(19) United States
(12) Patent Application Publication
(10) Pub. No.: US 2014/0319862 A1
(43) Pub. Date: Oct. 30, 2014

(54) TONGS WITH TEETH

(71) Applicants: Neal Ho, San Francisco, CA (US); David Chan, Scarborough (CA)

(72) Inventors: Neal Ho, San Francisco, CA (US); David Chan, Scarborough (CA)

(73) Assignee: BROWNE & CO., Markham, ON (CA)

(21) Appl. No.: 13/812,820

(22) PCT Filed: Jul. 26, 2011
(86) PCT No.: PCT/CA2011/000854

§ 371 Date: Jun. 7, 2013

Related U.S. Application Data
(60) Provisional application No. 61/368,426, filed on Jul. 28, 2010.

(51) Int. Cl. A47G 21/10; A47J 43/28

(52) U.S. Cl. CPC A47G 21/10; A47J 43/283
USPC 294/99.2; 294/106

(57) ABSTRACT

There is provided a pair of tongs for grasping items comprising a pair of gripping ends, having a silicone and/or plastic exterior surface, where a first of the pair of gripping ends further comprises a set of metal teeth projecting toward the second of the pair of gripping ends. Each of the first and second of the pair of gripping ends may comprises a body core at least partially covered by a (silicone) coating. In one embodiment, teeth are embedded within a plastic core. In another, the core comprises a metal frame from which the teeth project. The set of teeth may be spaced from a periphery of the gripping end. The second of the pair of gripping ends may also comprise metal teeth projecting toward the first of the pair of gripping ends.

### FIELD

The present matter relates to tongs for gripping items and more particularly to tongs with teeth.

### BACKGROUND

Tongs are widely used for gripping items such as food for cooking and/or serving. Silicone, plastics such as nylon or other heat-resistant compounds are often used for the construction of at least an exterior surface of the gripping ends. When wet, oily or greasy, plastic or silicone gripping ends are slippery and it may be difficult to pick up items.

### SUMMARY

There is provided a pair tongs for grasping items. The tongs comprise a pair of gripping ends, having a silicone and/or plastic exterior surface, where at least a first of the pair of gripping ends further comprises a set of metal teeth projecting toward the second of the pair of gripping ends. In accordance with one embodiment, each of the first and second of the pair of gripping ends comprises a plastic (e.g. nylon) body core at least partially covered by a silicone coating. The set of teeth are embedded within and project from the core of the First of the pair of gripping ends. The teeth may comprise a plurality apertures or other shape features about a portion of the teeth that are embedded in the core.

In another embodiment, each of the first and second of the pair of gripping ends comprises a (metal) frame, e.g. extending from respective arms of the tongs, for defining the body core, The frames are at least partially covered by a silicone coating. The teeth may be defined by at least one of the frames.

The teeth may be spaced from a periphery of the first of the pair of gripping ends. The teeth may comprise a single generally U- or V-shaped band. The metal may comprise stainless steel, The second of the pair of gripping ends may also comprise metal teeth projecting toward the first of the pair of gripping ends. The tongs may further comprise a respective pair of arms extending from the gripping ends. The arms may be coupled for movement at a hinge point (e.g. via a hinge pin) for movement between an open and a closed position. in a closed position the teeth of the first of the pair of gripping ends may abut an opposing face of the second of the gripping ends. The tongs may comprise a locking mechanism to lock the tongs in a closed position. The tongs may comprise a biasing mechanism for normally biasing the tongs to an open position (i.e. when not squeezed or locked in the closed position).

### BRIEF DESCRIPTION OF THE DRAWINGS

The present matter may be further understood by reference to following description in conjunction with the appended drawings in which:

FIG. 1 is a perspective view of a pair of tongs in a closed position in accordance with one embodiment;

FIG. 2 is a perspective view of one of the gripping ends of the pair of tongs of FIG. 1;

FIG. 3 is a perspective view of selected components of the gripping end of FIG. 2 in accordance with an embodiment; and

FIG. 4 is a side view, in longitudinal cross-section, of the gripping ends of the pair of tongs of FIG. 1;

FIGS. 5 and 6 are respective perspective views of selected components about the gripping ends of a pair of tongs in accordance with another embodiment; and

FIG. 7 is a side view, in longitudinal cross-section, of the gripping ends of FIGS. 5 and 6.

In the following description like numerals refer to like structures and processes in the diagrams.

### DETAILED DESCRIPTION

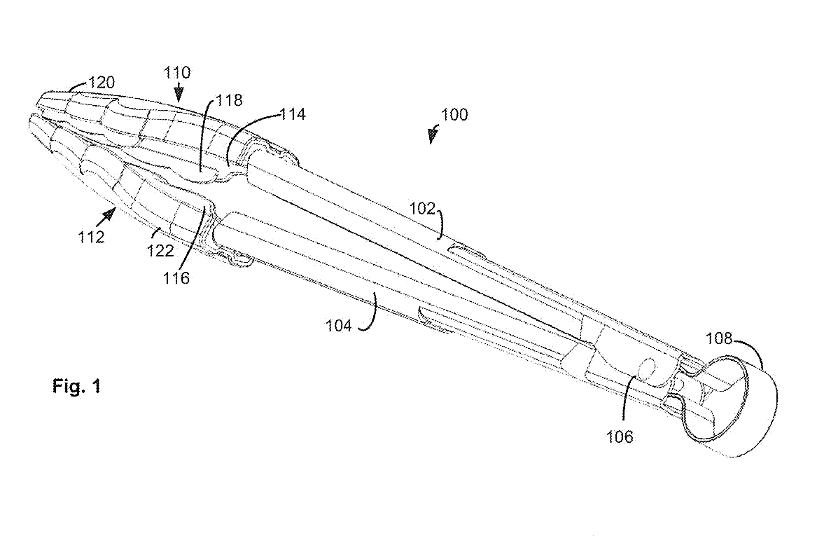

FIG. 1 is a perspective view of a pair of tongs 100 (herein after tongs 100) in a closed position in accordance with one embodiment, Tongs 100 comprise a pair of arms 102, 104 coupled for pivoting about a hinge or pivot point (e.g. pin) 106, a locking mechanism 108 and gripping ends 110 and 112. Various locking mechanisms 108 may be used. In the present embodiment a bow spring locking mechanism as shown and described in U.S. Pat. No. 6,056,338, entitled “Lockable Kitchen Tongs”, issued May 2, 2000 (incorporated herein by reference) is at least partially illustrated. Other locking mechanisms may include those described in U.S. Pat. No. 7,311,344 B2 entitled “Lockable Tongs”, issued Dec. 25, 2007 and also incorporated herein by reference.

Arms 102 and 104 are normally biased to an open position where the gripping ends are apart, when not locked or squeezed closed, such as via the locking mechanism or separate biasing mechanism such as a spring (not shown).

In the illustrated embodiment, each of the first 110 and second 112 of the pair of gripping ends comprises a body core 114 and 116, The body may comprise a plastic material. One example is nylon though other plastics may be utilized. Each core may be at least partially coated (e.g. by overmoulding) in a respective coating of silicone 120, 122. The coatings 120, 122 may be applied to a surface of the core that is likely to contact or be positioned close to a hot cooking surface (e.g. of a pot, pan, grill etc.) Silicone is typically softer than nylon but more heat resistant. Silicone is typically slippery when wet or oily/greasy.

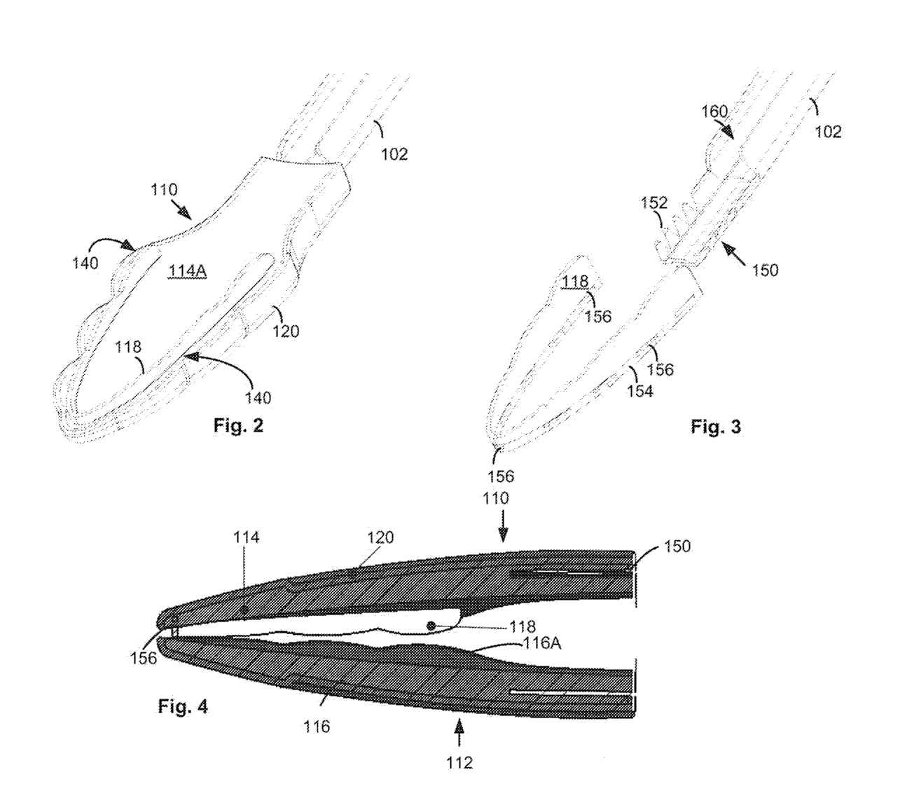

FIG. 2 is a perspective view of the first of the gripping ends 110 of the tongs 100 of FIG. 1, FIG. 3 is a perspective view of teeth 118 and arm 102 of the gripping end of FIG. 2 in accordance with an embodiment. FIG. 4 is a side view, in longitudinal cross-section, of the gripping ends of the tongs 100.

Teeth 118 are embedded in core 114 and project from a surface 114A (FIG. 2) toward an opposing surface 116A (FIG. 4) of the second of the pair of gripping ends. Teeth may be spaced (e.g. about 2 mm to 5 mm) from a periphery 140 of the gripping ends. The spacing may be assistive to avoid contact between the teeth and a cookware surface such as a non-stick coated pot or pan when in use.

With reference to FIGS. 3 and 4, teeth 118 may comprise a metal band that may be generally U- or V-shaped to conform to a broad outer shape of the gripping ends. A portion 154 of the teeth 118 embedded into the core 114 may define a plurality of apertures 156 or other shaped features for assisting with embedding. In the illustrated embodiments the band of teeth are representative of possible shapes and configurations. To assist with cleanup for example, the illustrated teeth 118 are not individually separated by gaps or spacing where food particles may become lodged, Teeth 118 are shown relatively flat (not sharpened or pointed) to assist with the release of grasped items when the tongs 100 are opened, A wavy profile may be used to assist with gripping of items.

Teeth 118 are shown in a single gripping end 114 but may be in both gripping ends 114 and 116 (not shown). In such an embodiment, the respective teeth may be relatively spaced such that they do not contact one another when the tongs are closed but abut the opposing face of the other gripping end. Teeth 118 are shown as a single band for ease of construction. Teeth in one of the pair of gripping ends may be defined via more than one element.

Tong arms 102, 104 may be inserted into cores 114, 116 such as by heat insertion. In FIG. 3, end 150 of arm 102 is shown with shape features 152, such as a plurality of projections, for assisting with the secured embedding of the arm 102 in the core. Arm 104 may be similarly configured (not shown). Arms 102, 104 may comprise metal material such as stainless steel. The material may be cut and bent (formed), as may be necessary, to define an arm of desired shape, Cooperating channels 160 may be defined along the arms or at least at the ends opposite the gripping ends, within which to house the locking mechanism and/or biasing mechanism.

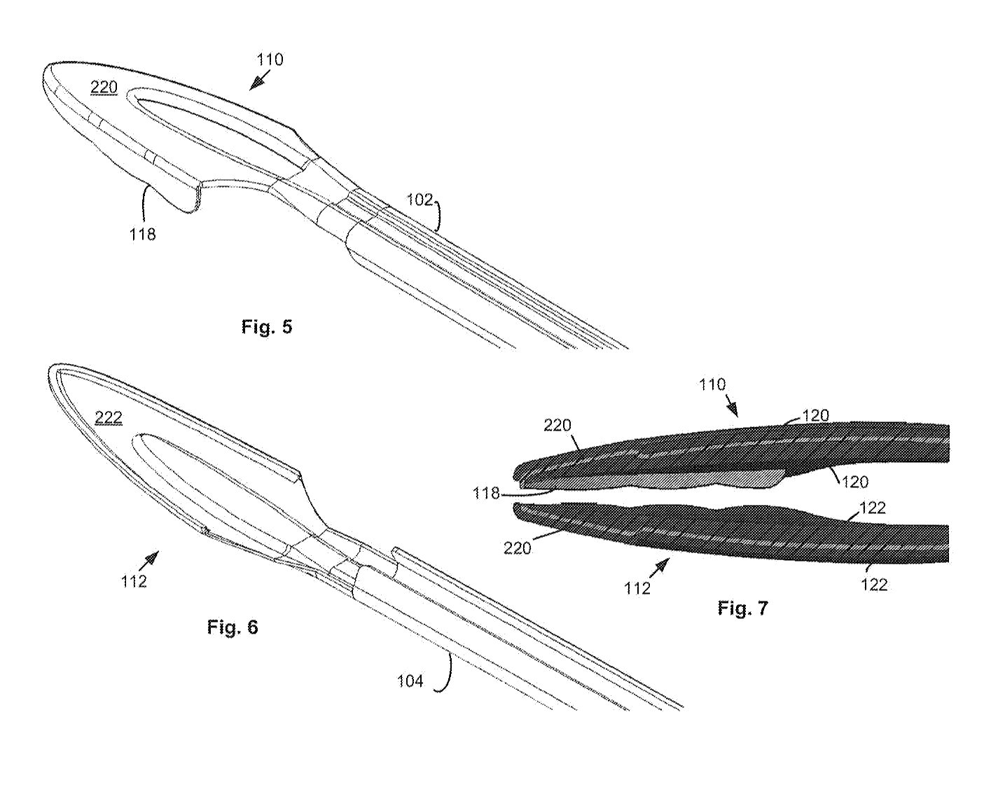

FIGS. 5 to 7 illustrate a different embodiment of tongs 100, without a plastic (nylon) or body 114 or 116. In the present embodiment, heads 110 and 112 comprise body cores defined by frames (e.g. of stainless steel or other metal) 220 and 222 within silicone coatings 120 and 122. The frames may be extensions of arms 102 and 104. That is, a respective arm and frame (e.g. 102 and 220 or 104 and 222) may be defined from the same sheet metal substrate, cut and bent (shaped) to the desired configuration, for example to form teeth 118 in head 110 but without teeth in head 112. The cross-section view of FIG. 7 shows silicone coatings 120 and 122 which may be overmoulded onto the frames 220 and 222. Though not shown, the remaining portion of the arms, a pivot and a locking and/or biasing mechanism may be provided, for example, as per FIG. 1.

To manufacture tongs 100 of the embodiment of FIGS. 2 to 4, metal components such as arms 102, 104 and teeth 118 may be cut (e.g. stamped) and bent into desired shapes. Cores 114 and 116 may be formed such as in a mould. Teeth 118 may be overmoulded in the process of forming the cores 114, 116 or subsequently heat inserted. The arms 102, 104 may be respectively heat inserted into the cores 114, 116. Silicone coatings 120, 122 may be overmoulded onto the respective cores 114, 116. The pivot 106, locking mechanism 108 and/or biasing mechanism may be assembled and the arms 102, 104 joined. Variations in the order of these steps may be contemplated.

To manufacture tongs 100 of the embodiment of FIGS. 5 to 7, metal components such as arms 102, 104 and frames 220 and 222 may be cut (e.g. stamped) and bent into desired shapes. For example, frame 220 has teeth 118 about at least a portion of a perimeter of the frame. Silicone bodies 120, 122 may be overmoulded onto the respective frames 220, 222. Such bodies 120, 122 are generally about the whole of the frames 220, 222 to define a relative interior facing surfaces, for gripping food items, and exterior surfaces, which may come in contact with cookware (not shown). The arms 104 with silicone bodies 120, 122 over frames 220 and 222 may be treated (e.g. through heating) to meet various safety standards or protocols, such as LFGB tests, for food service and/or consumer protection for products employing silicone. The pivot 106, locking mechanism 108 and/or biasing mechanism may be assembled and the arms 102, 104 joined. Variations in the order of these steps may be contemplated.

Though shown coupled at respective ends thereof, arms 102 and 104 and may be coupled in a middle portion. Ends opposite the grasping ends may be configured and operated like scissors.

it will be appreciated by those of ordinary skill in the art that the matter can be embodied in other specific forms without departing from the spirit of essential character thereof.

1. A pair tongs for grasping items comprising:
a pair of gripping ends, having a silicone or plastic exterior surface, a first of the pair of gripping ends further comprising a set of metal teeth projecting toward a second of the pair of gripping ends.

2. The tongs of claim 1 wherein each of the first and second of the pair of gripping ends comprises a body core at least partially covered by a silicone coating.

3. The tongs of claim, 2 wherein the body core comprises a metal frame or a plastic body.

4. The tongs of claim 1 wherein, at least one of:
the set of teeth project from the core of the first of the pair of gripping ends;
the set of teeth are embedded within a plastic core or silicone coating;
the set of teeth are spaced from a periphery of the first of the gripping ends;
the set of teeth comprise a single generally U- or V-shaped band;
the set of teeth comprise stainless steel; and
the set of teeth comprise a plurality apertures about a portion of the teeth that are embedded in the core,

5. The tongs of claim 1 wherein the second of the pair of gripping ends comprises a respective set of metal teeth projecting toward the first of the pair of gripping ends.

6. The tongs of claim 1 comprising a respective pair of arms extending from the gripping ends.

7. The tongs of claim 6 wherein the arms are coupled for movement at a hinge point for movement between an open and a closed position.

8. The tongs of claim 6 wherein, in a closed position, the set of teeth of the first of the pair of gripping ends abut an opposing face of the second of the gripping ends.

9. The tongs of claim 6 wherein an end of each of the respective arms defines, a frame to provide the body core.

10. The tongs of claim 1 wherein at least one of the frames comprises the set of teeth.

11. The tongs of claim 1 comprising a locking mechanism to lock the tongs in a closed position.

12. The tongs of claim 1 comprising a biasing mechanism for normally biasing the tongs to an open position.

13. A pair tongs for grasping items comprising:
a pair of arms coupled for pivoting movement between an open and a closed position, each arm having a respective gripping end, each gripping end comprising a frame extending from the arm and having a silicone coating over at least a portion of a surface of the frame, at least one of the gripping ends further comprising a set of metal teeth projecting toward the other of the gripping ends.

14. The pair of tongs of claim 13 wherein the silicone coating of the other of the gripping ends covers a surface of the frame of the other of the gripping ends, the surface facing the teeth when the gripping ends are in the closed position.
